(19) United States
(12) Patent Application Publication
(10) Pub. No.: US 2026/0016783 A1
(43) Pub. Date: Jan. 15, 2026

(54) STRUCTURE, CASING, AND IMAGE FORMING APPARATUS

(71) Applicant: CANON KABUSHIKI KAISHA, Tokyo (JP)

(72) Inventor: DAISHIRO SEKIJIMA, Tokyo (JP)

(21) Appl. No.: 19/260,102

(22) Filed: Jul. 3, 2025

(30) Foreign Application Priority Data
Jul. 11, 2024 (JP) 2024-111599

(51) Int. Cl. G03G 15/00; G03G 21/16

(52) U.S. Cl. CPC G03G 15/80; G03G 21/1619; G03G 21/1633; G03G 21/1652; G03G 2221/166

(57) ABSTRACT

A structure including a first plate portion having conductivity and a second plate portion having electrical continuity, the structure includes a first electrical connection member and a second electrical connection member extending from the first plate portion and each having an end portion that is an open end, wherein, in a state where the first plate portion and the second plate portion are joined, the first electrical connection member is arranged in contact with the second plate portion, and the second electrical connection member is arranged out of contact with the second plate portion, and wherein an electrostatic capacitance between the second electrical connection member and the second plate portion is between 1.4 picofarad (pF) and 100 pF, inclusively.

### BACKGROUND

### Field of the Technology

The present disclosure relates to a structure, a casing, and an image forming apparatus.

### Description of the Related Art

An electronic device includes electric circuitry including a plurality of circuits capable of inputting or outputting signals. When each of the circuits operates, an electric current corresponding to the operation propagates through a printed circuit board on which the electric circuit is mounted, generating high-frequency noise current and voltage that flow through electrical contacts between devices into devices having conductivity. Such a structure via electrical contacts may constitute a resonant system in a specific frequency band, which poses an issue due to generation of significant unwanted radiated noise. Japanese Patent Application Laid-Open No. 9-283191 discusses a configuration in which components of an electronic device are electrically connected via spring members.

### SUMMARY

According to some embodiments, a structure including a first plate portion having conductivity and a second plate portion having electrical continuity, the structure includes a first electrical connection member and a second electrical connection member extending from the first plate portion and each having an end portion that is an open end, wherein, in a state where the first plate portion and the second plate portion are joined, the first electrical connection member is arranged in contact with the second plate portion, and the second electrical connection member is arranged out of contact with the second plate portion, and wherein an electrostatic capacitance between the second electrical connection member and the second plate portion is between 1.4 picofarad (pF) and 100 pF, inclusively.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are perspective views each illustrating a casing including a structure according to the present disclosure.

FIG. 2 is a schematic diagram illustrating a structure in a comparative example.

FIG. 3 is a graph illustrating simulation results of an example and the comparative example.

FIG. 4 is a diagram illustrating a first modification of a first exemplary embodiment.

FIG. 5 is a diagram illustrating a second modification of the present exemplary embodiment.

FIG. 6 is a perspective view illustrating an image forming apparatus to which the structure of the present exemplary embodiment can be applied.

FIG. 7 is a schematic view illustrating an image forming unit installed in the image forming apparatus.

### DESCRIPTION OF THE EMBODIMENTS

Some exemplary embodiments for which the present disclosure is implemented will be described with reference to the drawings. However, the exemplary embodiments described below are merely examples, and are not limited thereto. Common components will be described with reference to the plurality of the drawings, and the redundant description of the components denoted by the same reference numerals will be omitted as appropriate. Different elements referred to as the same name can be distinguished from each other by appending ordinal indicators, such as “a first element” and “a second element”.

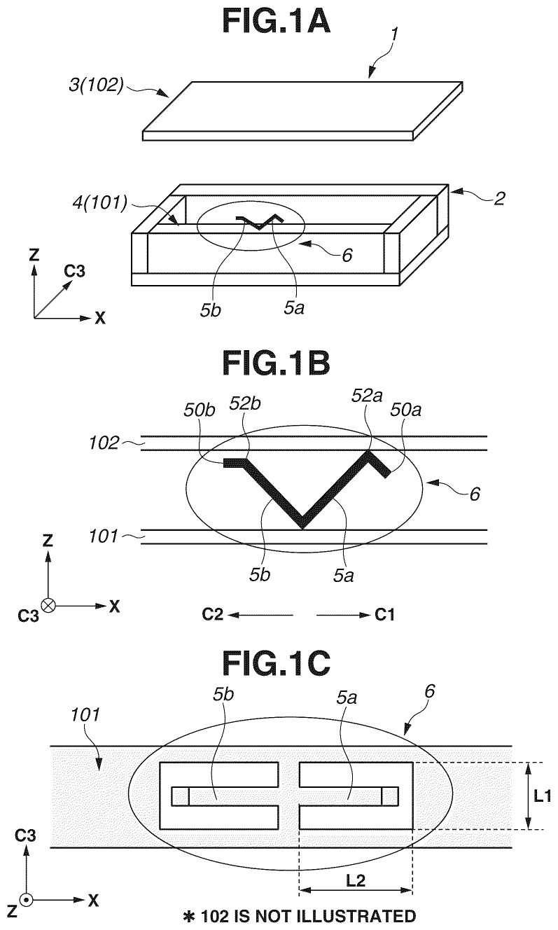

FIGS. 1A to 1C are perspective views each illustrating an application of a structure of the present exemplary embodiment of the present disclosure to a casing 1 including a metal plate. The casing 1 includes a case 2 formed of a metal plate and a cover 3 (a second plate portion) that covers the opening of the case 2. The case 2 includes an attachment surface 4 (a first plate portion) formed by bending an edge of the metal plate. By placing the cover 3 on the attachment surface 4 of the case 2, and fixing the cover 3 with screws or by welding, the casing 1 forms a box shape. The casing 1 can be used as a casing for a household electric appliance or a personal computer, a control box for a machine, such as a copier or a processing machine, or the like. Electric components or control-related devices can be attached or stored inside the case 2. The case 2 and the cover 3 are each formed of a conductive material, such as metal, for protection against static electricity or electromagnetic interference that occur inside the casing 1. A structure is configured to provide electrical continuity between the case 2 and the cover 3 so that when either the case 2 or the cover 3 is grounded, the other is also grounded. The conductive materials used for the case 2 and the cover 3 can be the same as or different from each other.

Materials of metal plates used for the case 2 and the cover 3 of the casing 1 are preferably conductive sheet metals with low electric resistance, such as iron or copper. The plate preferably has a thickness in the range of 0.4 millimeter (mm) to 1.2 mm. Any materials or sheet thickness can be used in an implementation of the present invention disclosure as long as the member is plastically deformable and electrically conductive.

A first exemplary embodiment will now be described. A structure 6 according to the present exemplary embodiment will be described with reference to FIGS. 1A to 1C. FIG. 1A is a perspective view illustrating an application of the structure 6 according to the present exemplary embodiment to the casing 1 including the metal plate. FIG. 1B is an enlarged front view of the structure 6 according to the present exemplary embodiment, as seen from a direction C3. FIG. 1C is an enlarged top view of the structure 6 according to the present exemplary embodiment, as seen from above (a second plate portion 102 is not illustrated).

The structure 6 is a structure of an electrical contact between a plate portion 101 (the first plate portion) and the plate portion 102 (the second plate portion). The plate portion 101 is, for example, disposed on the attachment surface 4 of the case 2. The plate portion 102 is, for example, disposed on the cover 3. The cover 3 is placed on the attachment surface 4, so that the plate portion 101 and the plate portion 102 are joined in an overlapping manner. Placing the cover 3 on the case 2 and establishing electrical continuity through the structure 6 makes it possible to reduce or eliminate leakage of high-frequency noise current or generation of significant unwanted radiation noise caused by a resonant system in a specific frequency band.

In each of FIGS. 1A to 1C, an elastic member 5a (a first electrical connection member) and an elastic member 5b (a second electrical connection member) are disposed on the attachment surface 4 of the case 2. However, the elastic members 5a and 5b can be disposed on the cover 3.

In other words, the plate portion 101 and the plate portion 102 of the structure are each included in either the case 2 or the cover 3 that covers the opening of the case 2.

In the structure 6 according to the present exemplary embodiment, the elastic members 5a and 5b are disposed on the plate portion 101, and the elastic members 5a and 5b respectively have open ends 50a and 50b. The elastic member 5a extends in a direction C1, whereas the elastic member 5b extends in a direction C2. In the present exemplary embodiment, the elastic member 5a extending from the plate portion 101 is arranged to extend in the direction C1 that is the opposite direction from the direction C2 in which the elastic member 5b extends.

Further, the elastic member 5b is not in contact with the plate portion 102, and an electrostatic capacitance between the elastic member 5b and the plate portion 102 falls within the range of 1.4 picofarad (pF) to 100 pF. Specifically, it is preferable that the distance between the elastic member 5b and the plate portion 102 is set to be at least 0.01 mm, and more preferably at least 0.1 mm for stability.

As illustrated in FIG. 1B, a bent portion 52a is provided near the open end 50a of the elastic member 5a, and a bent portion 52b is provided near the open end 50b of the elastic member 5b. The bent portions 52a and 52b are arranged so as to protrude toward the plate portion 102, and the elastic members 5a and 5b are configured to be deformable by an applied force.

While a length L1 and a length L2 are appropriately set within the range in which the elastic members 5a and 5b can be installed, the length L1 is preferably between 5 mm and 15 mm, and the length L2 is preferably between 30 mm and 50 mm from the standpoint of strength of the plate portion 101.

The elastic member 5a and the elastic member 5b are preferably formed by cutting and raising the case 2 or the cover 3, which are made of sheet metals. However, the elastic members 5a and 5B can be attached to the case 2 or the cover 3 later as separate components.

In order to establish electrical continuity between the case 2 and the cover 3, the cover 3 can be fixed to the case 2, for example, by fastening the respective edges of the case 2 and the cover 3 with not-illustrated screws. However, even when the case 2 and the cover 3 are fastened together with the screws, it is difficult to provide complete surface contact between the case 2 and the cover 3, and a gap may be formed. If such a gap is formed, a resonance phenomenon of the electric field may occur with the screw positions acting as nodes. Thus, when screws are provided at both ends of the case 2 and the cover 3, a resonance phenomenon occurs at a frequency corresponding to a wavelength that is twice the distance between the screws. To prevent such a resonance phenomenon, electrical continuity between the case 2 and the cover 3 can be established at a position where the electric field strength is highest, i.e., the midpoint between the two ends. By establishing electrical continuity at the midpoint, the resonance is shifted to twice its original frequency, which can prevent the phenomenon.

Generally, when elastic members are used to establish electrical continuity, the elastic members are preferably longer to enhance their strength. However, the inventor of the present disclosure has found that excessively increase of the length of an elastic member results in an increase in inductance. Thus, when an elastic member is made longer, the inductance increases and the resonance damping effect decreases. Conversely, shortening an elastic member can reduce the inductance as compared with the case where the elastic member is made longer, but the effect was insufficient. According to the present disclosure, degradation of electrical characteristics due to increased inductance can be effectively prevented by forming a capacitive connection between the elastic members.

An example will be described in detail.

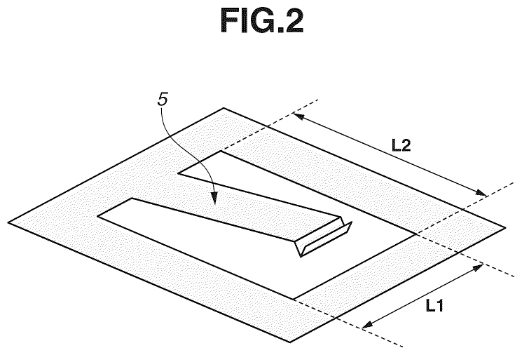

The electrical continuity characteristics of the structure 6 illustrated in FIG. 1 was obtained through simulation by varying its capacitance value. The transmission characteristics between the plate portion 101 and the plate portion 102 were calculated as the electrical continuity characteristics. The elastic members 5a and 5b of the structure 6 are modeled with the inductance of the structure of a comparative example illustrated in FIG. 2 as a parallel circuit, and a capacitance is connected in series to the inductance in the elastic member 5b.

The inductance of the structure illustrated in FIG. 2 will be described. In this structure, the length L1 is 10 mm, the length L2 is 41 mm, and a conductor thickness is 0.6 mm. The elastic member has a length of 40 mm and a width of 1 mm. At the bent portion of the elastic member, the elastic member is grounded via the plate portion 102 over a width of 1 mm×0.6 mm. The distance between the elastic member and the conductor surrounding the elastic ember is set to 2.66 mm. Under these conditions, the inductance value is 19 nanohenry (nH).

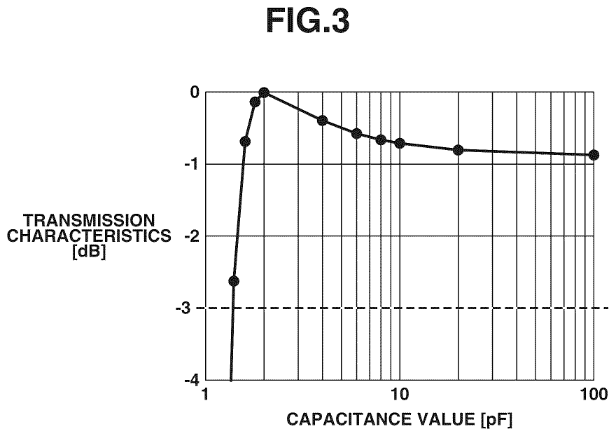

FIG. 3 illustrates simulation results. Values of the transmission characteristics are taken at 800 megahertz (MHz). On a vertical axis, values closer to zero indicate better transmission (i.e., better electrical continuity), while values below zero indicate poor transmission, meaning that electrical continuity is more difficult to obtain.

### COMPARATIVE EXAMPLE

The comparative example will be described with reference to FIG. 2. FIG. 2 differs from the example in having no elastic member extending in a direction opposite to an elastic member 5. The inductance value of the elastic member 5 illustrated in FIG. 2 is modeled at 19 nH as described above. A result of the electrical continuity characteristics is indicated by a dotted line illustrated in FIG. 3.

### Evaluation Result

As illustrated in FIGS. 1A to 1C, providing the structure 6 and setting the electrostatic capacitance value between 1.4 pF and 100 pF improved the electrical continuity that deteriorate due to increased inductance as compared with the case where the elastic member 5 alone is used. Further, setting the electrostatic capacitance value between 1.8 pF and 4 pF led to a significant improvement in electrical continuity.

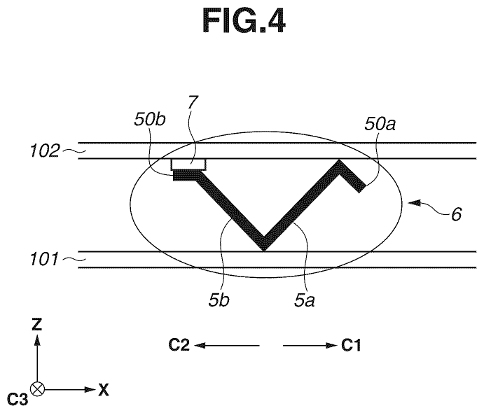

In the present exemplary embodiment, the elastic member 5b can be formed to increase the opposing surface area of the elastic member 5b with respect to the plate portion 102 in order to form capacitance. A dielectric member 7 made of a dielectric material can be interposed between the elastic member 5b and the plate portion 102, as illustrated in FIG. 4. With this configuration, capacitance can be formed even when the opposing surface area between the elastic member 5b and the plate portion 102 is small. The dielectric member 7 can be, for example, tape or a similar material. Incidentally, achieving a capacitance value of 1.4 pF without interposition of the dielectric member 7 may use, for example, a gap of 0.01 mm between the opposing surfaces when the opposing surface area is 2 mm². This involves extremely high precision in forming the plate portion 102 and the elastic member 5b, making it impractical. However, providing the dielectric member 7 can achieve the capacitance value.

In the present exemplary embodiment, an example is described where an elastic member is used as a second electrical connection member. However, the elastic member can be simply provided as an electrical-continuity plate.

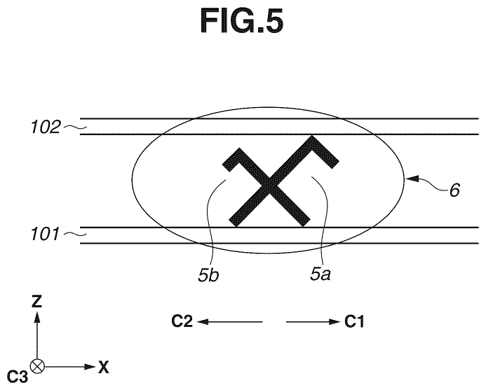

As illustrate in FIG. 5, the elastic members 5a and 5b can be arranged to face each other, and the elastic member 5a can be provided such that at least a part thereof is aligned with the elastic member 5b in a direction C3 that intersects with a direction C1 or C2.

As mentioned above, when screws (not illustrated) are provided at both ends of the case 2 and the cover 3, a resonance phenomenon occurs at a frequency corresponding to a wavelength that is twice the length L between the screws that electrically connect the case 2 and the cover 3. To prevent such a resonance phenomenon, electrical continuity between the case 2 and the cover 3 is preferably established at the position where the electric field strength is highest, i.e., at the midpoint between the two ends. In other words, electrical continuity between the case 2 and the cover 3 is preferably established near the midpoint between two adjacent screws (connection portions) that electrically connect the case 2 and the cover 3. Further, the elastic member 5b is preferably disposed within the range of ±L/4 from the midpoint where the electric field strength is highest. The elastic member 5b is more preferably disposed at the midpoint between the two adjacent screws. In other words, the elastic member 5b is preferably disposed within the range of −L/4 to L/4 relative to the elastic member 5a.

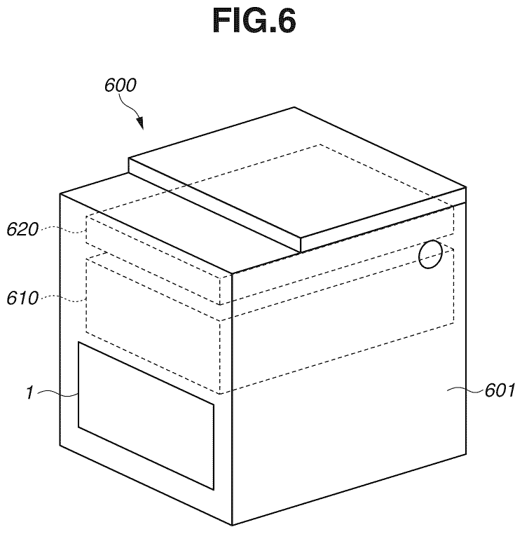

A second exemplary embodiment will now be described. FIG. 6 is a diagram for describing an image forming apparatus 600 as an example of an apparatus to which the casing 1 with the structure 6 according to the present exemplary embodiment can be applied.

The image forming apparatus 600 is, for example, an electrophotographic laser beam printer. The image forming apparatus 600 includes the casing 1, an exterior cover 601, an image forming device 610 and an image reading unit 620.

The image reading unit 620 is a device that reads images of set documents. The image forming device 610 forms images on sheets based on image data. Sheets are recording media including paper, such as plain paper, special paper, such as coated paper, an envelope, and index paper, a plastic film for overhead projector, and cloth.

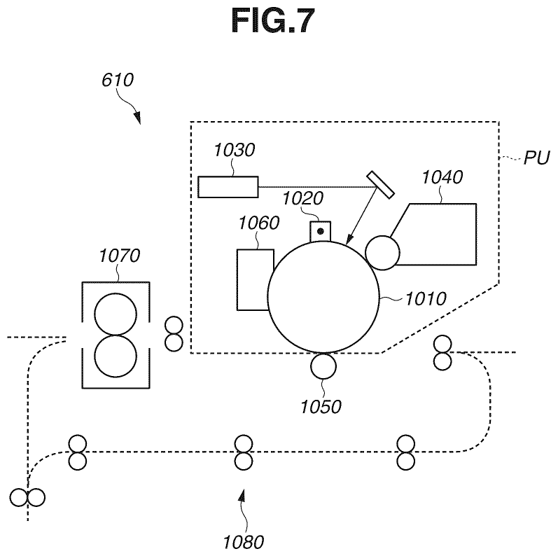

FIG. 7 is a schematic diagram of the image forming device 610 illustrated in FIG. 6. The image forming device 610 is controlled by a control device disposed inside the casing 1. The image forming device 610, as illustrated in FIG. 7, includes an electrophotographic image forming unit PU and a fixing device 1070. When an instruction for the start of an image forming operation is issued, a photoconductor drum 1010 of a photoconductor is rotated, and the surface of the photoconductor drum 1010 is uniformly charged by a charging device 1020. An exposure device 1030 then modulates and emits a laser beam based on the image data transmitted from the image reading unit 620 or an external computer, and scans the surface of the photoconductor drum 1010 to form an electrostatic latent image. The electrostatic latent image is developed using toner supplied from a developing device 1040 into a toner image.

A feeding operation of feeding sheets loaded in a cassette or a not-illustrated manual feed tray toward the image forming device 610 is performed in parallel with the image forming operation. The fed sheet is conveyed in accordance with progress of the image forming operation performed by the image forming unit PU. The toner image on the photoconductor drum 1010 is transferred to the sheet by the transfer roller 1050. The toner left on the photoconductor drum 1010 after the toner transfer is collected with a cleaning device 1060. The sheet with the toner image transferred thereon is conveyed to the fixing device 1070, and heat and pressure are applied to the sheet while the sheet is nipped by a pair of rollers. The sheet with the toner fused and fixed thereto is discharged to the outside by a pair of discharge rollers. If a double-sided printing is performed, the sheet is conveyed in a flipped state by a reverse conveyance unit 1080, and the image is formed on the reverse side of the sheet by the image forming device 610. The sheet is then discharged to the outside.

The image forming device 610 is an example of an image forming unit capable of forming an image on a sheet as a recording medium. Instead of the direct transfer method described above, the image forming device 610 can employ a configuration for an intermediate transfer method including an intermediate transfer member, or can employ another configuration for a method, such as an inkjet method.

The exemplary embodiments can be appropriately modified without departing from the technical concept of the present disclosure. For example, in the above exemplary embodiments, a case included in a casing includes a first plate portion, and a cover includes a second plate portion. However, the case may include the second plate portion, and the cover may include the first plate portion. The above exemplary embodiments have been described using an example of the casing where electrical continuity between the case and the cover is established. However, the present disclosure can be applied to any configuration as long as the structure has electrical continuity that is established between members having plate portions that overlap each other.

A configuration including a combination of the plurality of exemplary embodiments described above can be employed. Certain elements of at least one exemplary embodiment can be partially deleted or replaced. Further, new elements can be added to at least one exemplary embodiment.

The disclosure of the present specification includes matters explicitly described herein, as well as all matters that can be understood from the present specification and the drawings attached to the specification.

The disclosure of the present specification includes a complement of the individual concepts explicitly described herein. Thus, for example, if “A is greater than B” is described in the specification, it is conceivable that the specification discloses that “A is not greater than B” even if the statement “A is not greater than B” is not explicitly provided. This is because, in a case where “A is greater than B” is described, it is premised that the specification has considered the case where “A is not greater than B”.

The disclosure of the present disclosure will be described in the following.

### (Item 1)

A structure including a first plate portion having conductivity and a second plate portion having electrical continuity, the structure comprising:
a first electrical connection member and a second electrical connection member extending from the first plate portion and each having an end portion that is an open end,
wherein, in a state where the first plate portion and the second plate portion are joined, the first electrical connection member is arranged in contact with the second plate portion, and the second electrical connection member is arranged out of contact with the second plate portion, and
wherein an electrostatic capacitance between the second electrical connection member and the second plate portion is between 1.4 picofarad (pF) and 100 pF, inclusively.

### (Item 2)

The structure according to item 1, wherein the electrostatic capacitance is between 1.8 pF and 4 pF, inclusively.

### (Item 3)

The structure according to item 1 or 2, wherein a dielectric member is disposed between the second electrical connection member and the second plate portion.

### (Item 4)

The structure according to any one of items 1 to 3, wherein the second electrical connection member and the second plate portion is separated from each other by at least 0.01 mm.

### (Item 5)

The structure according to any one of items 1 to 4, wherein the first electrical connection member is disposed between two adjacent connection portions where the first plate portion and the second plate portion are connected.

### (Item 6)

The structure according to item 5, wherein a distance between the open end of the first electrical connection member and the open end of the second electrical connection member is between −L/4 and L/4, inclusively, where L is a length between the two adjacent connection portions where the first plate portion and the second plate portion are connected.

### (Item 7)

The structure according to any one of items 1 to 6, wherein the first electrical connection member is formed of an elastic member.

### (Item 8)

The structure according to any one of items 1 to 7,
wherein the first electrical connection member extends in a first direction, and the second electrical connection member extends in a second direction opposite to the first direction, and
wherein the first electrical connection member and the second electrical connection member are disposed being partially parallel.

### (Item 9)

A casing comprising:
the first plate portion and the second plate portion of the structure according to any one of items 1 to 8,
wherein the first plate portion is either a case or a cover that covers an opening of the case, and the second plate portion is the other.

### (Item 10)

The casing according to item 9, wherein a control device configured to control an electronic device is disposed inside.

### (Item 11)

An image forming apparatus comprising:
an image forming unit configured to form an image on a sheet,
wherein the image forming unit is controlled by the control device disposed inside the casing according to item 10.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-111599, filed Jul. 11, 2024, which is hereby incorporated by reference herein in its entirety.

What is claimed is:

1. A structure including a first plate portion having conductivity and a second plate portion having electrical continuity, the structure comprising:
a first electrical connection member and a second electrical connection member extending from the first plate portion and each having an end portion that is an open end,
wherein, in a state where the first plate portion and the second plate portion are joined, the first electrical connection member is arranged in contact with the second plate portion, and the second electrical connection member is arranged out of contact with the second plate portion, and
wherein an electrostatic capacitance between the second electrical connection member and the second plate portion is between 1.4 picofarad (pF) and 100 pF, inclusively.

2. The structure according to claim 1, wherein the electrostatic capacitance is between 1.8 pF and 4 pF, inclusively.

3. The structure according to claim 1, wherein a dielectric member is disposed between the second electrical connection member and the second plate portion.

4. The structure according to claim 1, wherein the second electrical connection member and the second plate portion is separated from each other by at least 0.01 mm.

5. The structure according to claim 1, wherein the first electrical connection member is disposed between two adjacent connection portions where the first plate portion and the second plate portion are connected.

6. The structure according to claim 5, wherein a distance between the open end of the first electrical connection member and the open end of the second electrical connection member is between −L/4 and L/4, inclusively, where L is a length between the two adjacent connection portions where the first plate portion and the second plate portion are connected.

7. The structure according to claim 1, wherein the first electrical connection member is formed of an elastic member.

8. The structure according to claim 1,
wherein the first electrical connection member extends in a first direction, and the second electrical connection member extends in a second direction opposite to the first direction, and
wherein the first electrical connection member and the second electrical connection member are disposed being partially parallel.

9. A casing comprising:
the first plate portion and the second plate portion of the structure according to claim 1,
wherein the first plate portion is either a case or a cover that covers an opening of the case, and the second plate portion is the other.

10. The casing according to claim 9, wherein a control device configured to control an electronic device is disposed inside.

11. An image forming apparatus comprising:
an image forming unit configured to form an image on a sheet,
wherein the image forming unit is controlled by the control device disposed inside the casing according to claim 10.
